(19) United States
(12) Patent Application Publication
(10) Pub. No.: US 2003/0112452 A1
(43) Pub. Date: Jun. 19, 2003

(54) Method and system for printer with multiple event logs

(76) Inventor: C. Kevin McIntyre, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/027,969

(22) Filed: Dec. 19, 2001

(51) Int. Cl. B41J 1/00; G06F 15/00

(52) U.S. Cl. 358/1.1; 358/1.15

(57) ABSTRACT

Methods and apparatus for maintaining multiple printer event logs in response to selected printer events, including errors. In one embodiment, a printer contains an error-detecting device and software for detecting a number of printer events. The printer further contains event logs maintained in a memory on the printer. At least one event log functions as a standard event log, tracking designated printer events in a wraparound file of a fixed number that may only be reset by changing a printer component or at a command entered by field support or maintenance personnel. A second event log may track information on printer events that are selected by a user, or may be generated from the first event log at a user command. The second log may be reset at any time. Additional event logs that are either fixed or selectable may optionally be included.

### FIELD OF THE INVENTION

The present invention relates generally to printers and methods of tracking printer errors and other printer events. More specifically, the present invention relates to generating multiple event logs that may be independently reset and maintained to allow printer usage to be more effectively monitored by different users.

### BACKGROUND OF THE INVENTION

Printers are well-known computer peripherals widely used in both home and business computing environments. Printer technology has made rapid advances over recent years. State of the art printers offer ever-increasing levels of speed, print quality, easily manipulated format options, and a wide variety of features, such as document collating, stapling, and various levels of print quality. Printers using inkjet or laser technology are capable of reproducing almost any image. As printer technology advances, the process of printing a document from a computer workstation involves ever increasing numbers of steps. Errors can occur at any of these steps. It has become common practice to keep an Aerror log@ or other logs in the printer memory disc or other storage device, to track printing errors and technical problems and any other type problem. The repair of inoperable or damaged printers can be aided by examining the error log for patterns of errors occurring prior to breakage. Other events occurring on a printer can be tracked and their occurrence can be similarly recorded. Where this is done, the error log may be expanded into a printer Aevent log.@

As it is used herein, the term Aprinter@ signifies any device capable of providing printer function alone or, alternatively, any device providing printer function in combination with one or more other document processing functions, such as, for example, copying, scanning, or facsimile capabilities.

Printer event logs are thus used to keep a record of the errors and other events occurring with the use of that printer. Presently, a single event log is maintained in the memory of the printer and may be examined by printer repair personnel, field support or maintenance personnel, printer designers or any other users. Examining the log of printer events allows the printer and its associated firmware, software and hardware, to be debugged, analyzed and repaired more efficiently. The event log is designed to track certain events occurring on the printer and these events and other additional events generally cannot be selected by a user for tracking.

The event log is generally kept as a wraparound file that lists a fixed number of printer events and as additional events occur, the older events are removed from the memory. To reset or clear the log and start tracking anew, requires either the replacement of a printer component or a command from the fieled support or maintenance personnel. The current design for an event log thus allows for efficient printer designing, debugging and similar analyses, and aids field support personnel in printer repair or reporting of printer consumable image supplies, modeling, etc. However, its single nature, limited entries and tracking of fixed events severely limit its usefulness to a printer end user. A system or method that is capable of keeping multiple event logs and allows users to select the printer events, would be a substantial improvement in the art.

### SUMMARY OF THE INVENTION

The present invention provides methods and apparatus for maintaining multiple printer event logs in response to selected printer events, including errors. In one embodiment, a printer contains an error-detecting device and a software for detecting a number of printer events. The printer further contains event logs maintained in a memory on the printer. One event log functions as a standard event log, tracking designated printer events in a wraparound file of a fixed number that may only be reset by changing a printer component or at a command entered by field support or maintenance personnel. Where included, a second log may track information on printer events that are selected by a user. The second log may be reset by a user at any time. Additional event logs may optionally be included. Alternatively, the printer may generate a second event log at predetermined times, or a user command, by drawing selected information from the standard event log. Methods of the present invention include providing a printer that is configured to maintain at least two event logs in its memory. As printer events occur and are detected by the printer, all designated errors are tracked in a first log, while selected errors are simultaneously tracked in a second log. These methods also include providing a printer configured to maintain a single event log in memory, from which additional event logs containing selected events may be generated. The second event log thus provides added functionality and usability to a printer user and also assists in the downloading of a file or files, general reports, alarms, or events.

### DESCRIPTION OF THE DRAWINGS

FIG. 1 is a block diagram of one embodiment of a printing device for use in the methods and system of the present invention.

FIG. 2 illustrates a system of network components that may be used in the methods and system of the present invention.

FIG. 3 is a flowchart showing a process of generating and maintaining multiple event logs in one embodiment of a method of the present invention.

FIG. 4 is a flowchart showing a process of generating multiple event logs in another embodiment of a method of the present invention.

FIG. 5 is a flowchart showing a process of tracking errors and generating multiple event logs in an embodiment of a method of the present invention.

### DETAILED DESCRIPTION OF THE INVENTION

The present invention provides methods and apparatus for maintaining multiple printer event logs for tracking printer events. In a preferred embodiment, the present invention makes use of a printer including an error detector to carry out the methods described herein.

It will be appreciated by those skilled in the art that the embodiments herein described while illustrating certain embodiments are not intended to so limit the invention or the scope of the appended claims. Those skilled in the art will also understand that various combinations or modifications of the preferred embodiments could be made without departing from the scope of the invention.

In a typical printing process over a network environment, a user at a computer workstation typically uses print driver software to load documents or images into a buffer (usually an area on a disk of a workstation), where a printer pulls them off the buffer at its own rate. Alternately, in many instances the data may go directly to the printer. The print driver functions to convert the text, graphics and print attributes specified by the user=s workstation into a set of codes that the printer can translate and/or read. The set of codes is typically a version of Printer Control Language (PCL), developed by Hewlett-Packard for its dot-matrix, inkjet, and LaserJet series printers. Once the text, graphics and print attributes have been converted to PDL, the PDL is transmitted by the workstation over the network where it is received by the printer as a Aprint job.@ Examples of PDLs include Hewlett Packard=s HP-GL/2 language and Adobe=s PostScript.

As the printer receives the coded language from the print driver, it stores the information in high capacity memory storage (job retention), which typically comprises random-access memory (RAM) or a hard disk. A stored print job thus comprises one or more electronically stored files and the print attributes associated therewith. Before a typical print job (e.g., a PDL file) can be printed, however, its contents must be converted to a bit-mapped image format, also known as a raster image. The raster image is a bit-mapped representation of the document to be printed, with each bit in the bitmap representing the absence or presence of a dot (or pixel) on the printed page. A raster image processor (ARIP@) in the printer typically translates PDL files to a raster image, also called a ARIP=ed@ version of the file. Thus, the print files include data representing graphical images and the RIP=ed version is generated from the print file. Typically, print jobs are RIP=ed before storage in job retention, making them Aprint ready files.@ In some cases, print jobs are received by the printer in the form of raster image data. In that case, a processor in the printer may engage in pixel image manipulation when storing the print job. The printer then uses the data in the print ready file to control the mechanical printing components and the printing steps, such as paper feeding, controlling the inkjets of an inkjet printer or the laser scanning assembly and revolving drum and other associated mechanism of a laser printer. The occurrence of each step described above is an event that can be tracked. Errors can be introduced into the process at any of the above steps. The occurrence of an error is also an event that can be tracked.

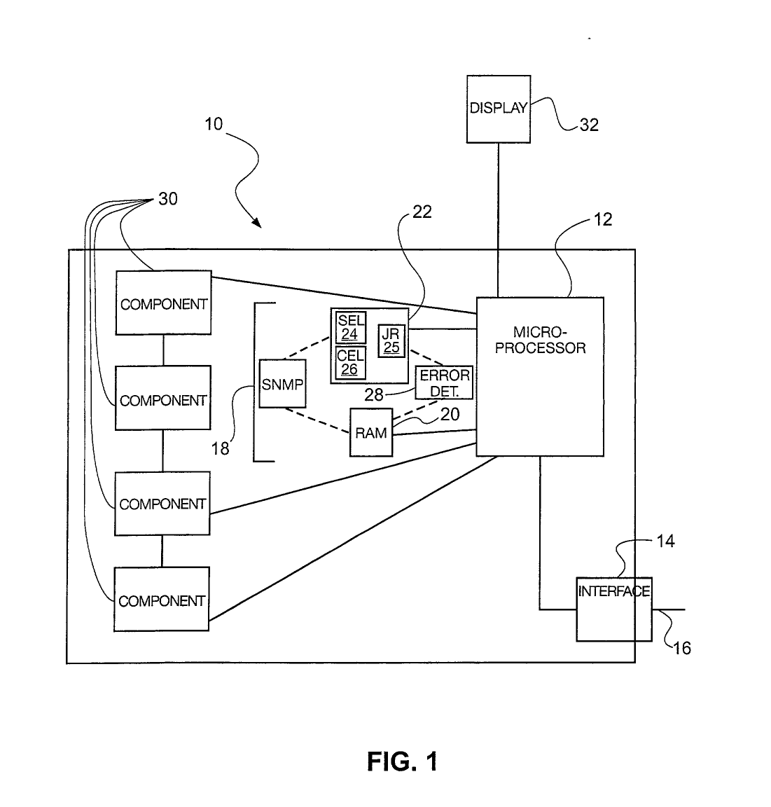

Referring to FIG. 1, one possible embodiment of a preferred printer 10 for carrying out the methods of the present invention is shown. Printer 10 is configured with both printer specific hardware and software. The printer specific hardware and software of printer 10 may be provided in any conventional printer configuration known in the art, including those associated with laser printers, impact printers, photographic printers, and inkjet printers. Printer 10 optionally may include one or more local displays 32 (not shown), which may comprise a conventional monitor, a monitor coupled with an integrated display, an integrated display (e.g., an LCD display), or other means for viewing print queues, print attributes, and associated data or processing information, including printer specific information. Printer 10 also includes a network interface (I/O) 14 for bidirectional data communication through one or more and preferably all of the various networks (LAN, WAN, Internet, etc.) using communication paths or links known in the art, including wireless connections, Ethernet, bus line, Fibre Channel, ATM, standard serial connections, and the like.

In some embodiments, the printer 10 may optionally include an embedded Web interfacing system comprising a Web server providing one or more Web server functions to requesting users linked by way of one or more of the various networks (LAN, WAN, Internet, etc.). The preferred printer 10 of the present invention may thus be the same or conceptually similar to the printer apparatus configured with an embedded Web server described in U.S. Pat. No. 5,956,487 to Venkatraman et al., assigned to the assignee of the present invention, the disclosure of which is incorporated herein by reference in its entirety.

Still referring to drawing FIG. 1, the printer 10 includes microprocessor 2, which is preferably part of the existing circuitry associated with a conventional printer. As such, microprocessor 12 is preferably configured to perform some or all of the printer specific functions of printer 10, including control of printer specific hardware and software. Where printer 10 includes optional features, such as a web server, microprocessor 20 may be configured to control and execute those optional features.

Microprocessor 12 is provided with memory 18 in the form of RAM 20 and/or hard disk memory 22, which may be associated with the print cache of printer 10, or which may be provided separately from the print cache. As used herein, printer memory designated for temporarily or permanently storing one or more print jobs on hard disk memory 22 or other data storage device in printer 10 is referred to as Ajob retention@ 25. In preferred embodiments, a percentage of memory 18 in printer 10 is dedicated to standard event log 24 (ASEL 24@). In some preferred embodiments, in addition to the SEL 24, a percentage of memory 18 is dedicated to a customizable event log 26 (ACEL 26@). Typically, printer 10 will be equipped with 64 megabytes of RAM 20, although less RAM may be used in certain configurations.

Preferably, microprocessor 12 of printer 10 is configured to translate coded language received from printer drivers of networked workstations into a bit-mapped image format (raster image format), and to store the translated print files in high capacity memory storage (i.e., job retention 25). Thus, the resulting ARIP=ed@ print jobs, representing graphical images of text or drawings along with associated print attributes, are stored in job retention 25 as Aprint ready files.@

Printer 10 will preferably contain executable software programs stored on hard disk memory 22 related to the operation of printer specific hardware. Alternatively, a separate hard disk (not shown) may optionally be provided with the requisite software programs for printing.

Mechanical components 30 of printer 10 are the mechanisms, which are used to handle paper and print documents. Mechanical components 30 may include the paper feeding mechanism, the inkjets of an inkjet printer, the laser scanning assembly and revolving drum and other associated mechanisms of a laser printer, or other printing mechanisms known, now or in the future, to those skilled in the art.

An error detector 28 located within the printer 10 monitors each step of the process of receiving, translating, storing and printing a print job. Preferably, error detector 28 functions as microprocessor 12 follows a set of instructions contained in a software program retained in memory 18 to check for errors at each step of the process of receiving, translating, storing and printing a print job. Alternatively, error detector 28 could be an additional processor, which is solely dedicated to the error detection function. It will be appreciated that any method or system known, now or in the future, to those skilled in the art may be used to detect the errors from which error messages are generated. All such methods and systems are included within the scope of the present invention. Examples of some possible error detectors, among others that may be used in the present invention, are disclosed in U.S. Pat. No. 5,620,264, issued Apr. 15, 1997 to Kagita, and U.S. Pat. No. 5,625,757, issued Apr. 29, 1997 to Kageyama et al., each of which is incorporated herein by reference.

A number of daemons, represented by box 29, are located in the printer and detect specific printer events, similar to error detector 28. A daemon is a device, such as an SNMP device, contained in a computer component that monitors a site, such as a network node for a specific event. When that event occurs, the daemon creates a message, such as an SNMP trap, that is logged into an event log. It will be appreciated that the error detector 28 may consist of a number of daemons 29 that monitor printer functions, including each step of the printing process, for errors.

SEL 24 receives and maintains event messages from daemons 29 and error messages from error detector 28. Preferably, SEL 24 maintains every event message and error message that is conveyed to it. Alternatively, SEL 24 may be configured to accept and maintain only certain messages. In one preferred embodiment, the messages accepted by SEL 24 may not be selected by the printer end user, and the SEL 24 count may only be reset by the replacement of a printer 10 component or the entry of a command that is available only to field support or manufacturer personnel. It is preferred that SEL 24 be configured as a wraparound file taking up to only a preset percentage of memory 18. SEL 24 may thus contain a preset number of prior printer events, such as 50 or 100, that may be viewed and examined.

In contrast, in embodiments where CEL 26 is maintained, it has a configuration that may be set and altered by a user of the printer 10, such as a network administrator. Event messages and error messages conveyed to CEL 26 are accepted if they have been selected for tracking in CEL 26. Selected messages are then written into the CEL 26. While CEL 26 may be maintained as a wraparound file containing a preset number of messages, it is preferred that the user select if CEL 26 will act as a wraparound file or as an expanding memory file. Where CEL 26 is a wraparound file, it is preferred that the user select the number of messages maintained therein. It is preferred that CEL 26 may be reset, cleared or reconfigured by a user at any point, using simple commands or through the use of a user interface.

It will be appreciated that multiple event logs may be maintained in the memory 18 of the printer 10 in manners differing from that described above and still fall within the scope of the present invention. For example, multiple CELs 26 may be maintained along with SEL 24. In such an embodiment, each CEL 26 may be configured to select a single or a few printer events, allowing the occurrence of those events to be tracked separately. Alternatively, two or more CELs 26 with differing configurations may be maintained in the memory 18, without a SEL 24, allowing the tracking of different events.

In alternative embodiments within the scope of the present invention, a separate CEL 26 is not maintained in memory 18. Instead, one or more SELs 24 is maintained and may be expanded in size. When a user desires to track selected events, the entry of a command causes a virtual customizable event log (VCEL 27, not shown in FIG. 1) To be generated for the selected event messages maintained in SEL 24. The VCEL 27 may be generated each time a command is entered, at predetermined times, or as otherwise desired. It is preferred that VCEL 27 be displayed upon generation and it may be stored in memory 18, or on the memory of a device in communication with printer 10.

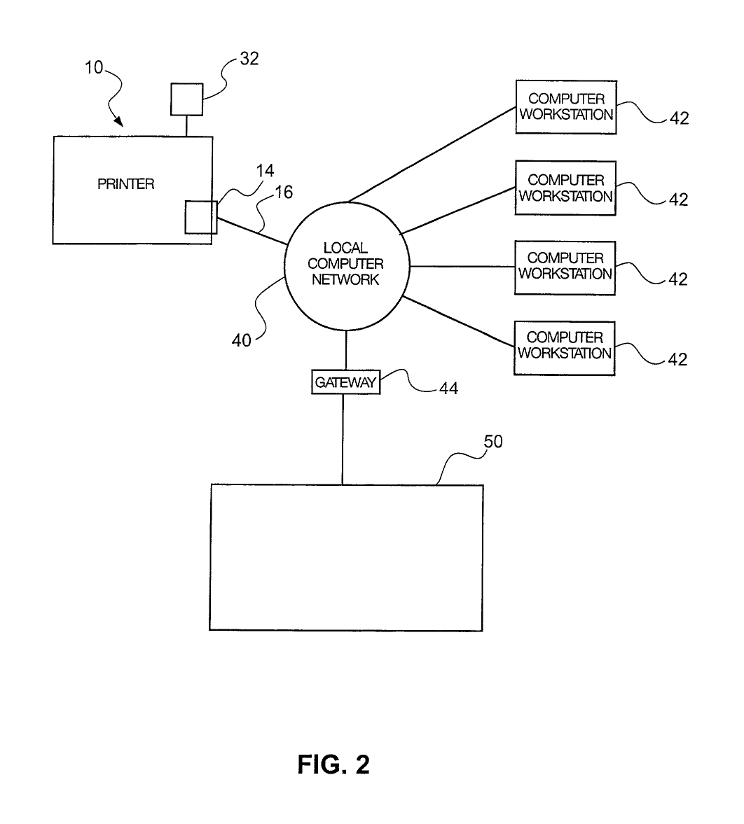

Referring now to drawing FIG. 2, printer 10 is shown as connected to a local computer network 40 through network interface 14 and connection 16. A number of computer workstations 42 are also connected to the network 40. Printer 10 is able to accept print jobs from each workstation 42 through network operative connections as known to those skilled in the art. Local network 40 architecture also includes a gateway 44, which will typically comprise a software and/or hardware firewall. Gateway 44 functions to block various external data transmissions from being sent to locations residing inside local network 40 architecture. In this regard, gateway 44 may be restrictively configured to allow remotely situated users to access web pages within local network 40 architecture (e.g., via HTTP protocols) and to block all other access. Gateway 44 also provides a port for outgoing Internet traffic. Gateway 44 is further preferably configured to internally route IP-Packets sent from workstations 42 to other web-based devices (e.g., printer 10) also residing within local network 40 architecture, and vice versa.

It is preferred that both the SEL 24 and CEL 26 be accessible for examination by a printer user, such as a network administrator. This may be accomplished in a number of ways. One such way is to allow the contents of either event log to be displayed on the optional attached display 32 (not shown), or on a display controlled by a connected workstation 42. The contents of a log may be accessed by a user in a number of ways. For example, a user may access the control panel for the printer, which is displayed on the display 32, or a workstation 42 display. Within the displayed control panel are commands that may be executed to display the contents of the event logs. The commands are preferably executed by the user Aclicking@ thereon to select them. Execution of a command to display an event log, such as SEL 24, causes the contents of that log to be displayed, or in the case of VCEL 27, to be generated and displayed.

In embodiments where CEL 26 is displayed on a workstation 42, it is preferred that the contents be displayed as a web page, or web page-like interface, generated in a web browser program running on the workstation 42. The web page may be generated by a web server included in the printer 10. The display of the contents of the CEL 26, will preferably include commands allowing the configuration of the CEL 26 to be altered. For example, the selection of events tracked may be altered or the number of event messages maintained in the CEL 26 may be adjusted through the display or the control panel.

Alternatively, the attributes of the CEL 26 may be altered or the contents of either event log may be displayed by entering commands into the utility managing the printer over the network 40. A number of utilities are currently available, allowing one or more printers 10 to be connected to and managed over a network 40. One such utility is WebJetAdmin, which is a product of Hewlett Packard. One advantage of WebJetAdmin is that it allows the management to be controlled using a web browser program. It will be appreciated that any such utility known now, or in the future, to those skilled in the art may be used. When a network administrator runs WebJetAdmin or other utility to control the printer 10 on a network 40, a number of commands related to the printers may be entered and executed. These commands may alter the configuration of the CEL 26, or cause the contents of either event log, CEL 26 or SEL 24, to be displayed. For example, a web browser program is used to display a web page-like interface generated by Web Jet Admin. It will be appreciated that the term Aweb page-like@ as used herein refers to any display that may be generated and displayed in a web browser program, including web pages and other data files. There are a number of such displays that may be generated and execution of commands in each display can lead to the display of further interfaces. Using the commands from a series of displays, a single web page like interface is displayed for a printer 10 attached to the network 40. Within this interface are a number of commands that may be selected and printer configurations that may be altered. Among these commands are commands to display the contents of the printer event logs. Execution of the appropriate command, preferably an HTML button, displays the contents of either the SEL 24 or the CEL 26. Other commands accessible through the utility allow the configuration of the CEL 26 to be altered. It will be appreciated that the above examples are illustrative only and that any suitable program, interface or method for displaying the contents of SEL 24 or CEL 26 may be used and is within the scope of the present invention.

In embodiments where VCEL 27 is generated and then displayed on a workstation 42, it is preferred that the contents be displayed as a web page, or web page like interface, generated in a web browser program running on the workstation 42. The web page may be generated by a web server included in the printer 10. The display of the contents of the VCEL 27, will preferably include commands allowing the configuration of the VCEL 27 to be altered. For example, the selection of events, or the number of event messages displayed in VCEL 27 may be adjusted through the display or the control panel. It will be appreciated by those skilled in the art that VCEL 27 may alternatively be generated and displayed through a network utility, such as WebJetAdmin over network 40.

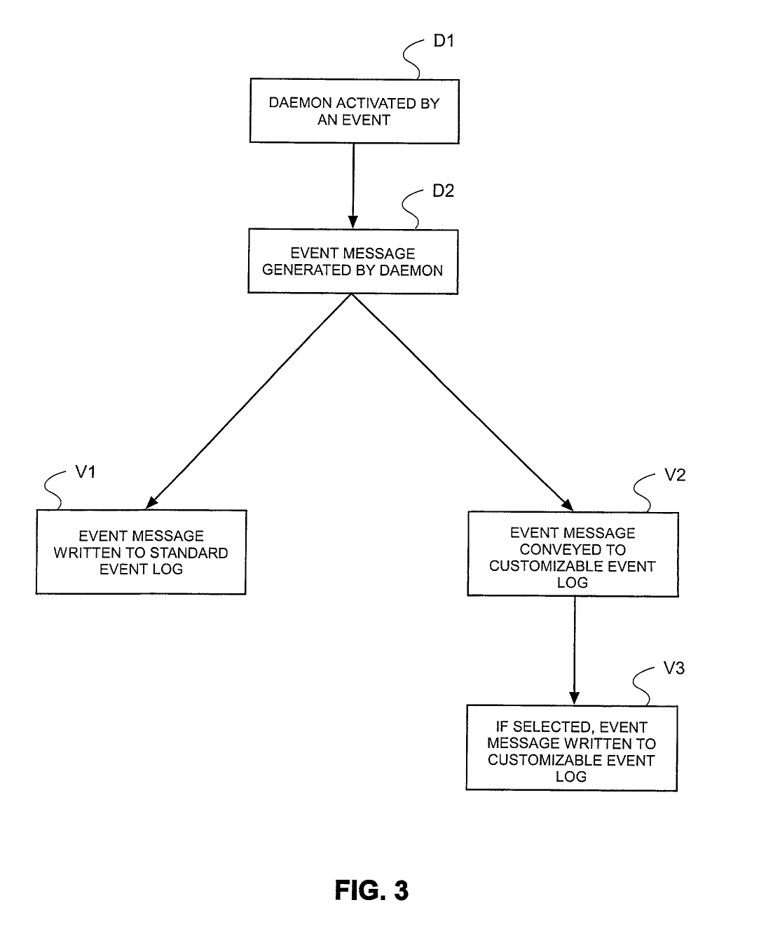

Turning to FIG. 3, one possible embodiment of a process for tracking printer events is described. For illustrative purposes, this process will be discussed as it would take place in connection with the embodiment of FIGS. 1 and 2, but it will be appreciated that the process may be used on any suitable system. A daemon 29, such as an SNMP (simple network management protocol) device, monitors the printer 10 for the occurrence of an event, such as the usage of a printer mechanical component like a collator or stapler. It will, of course, be appreciated that any event occurring on the printer may be monitored and that any suitable monitoring device or program may be used and is within the scope of the present invention. The daemon 29 is activated by the occurrence of the triggering event, as shown in box D1. Upon the occurrence of the event, daemon 29 generates an event message, such as an SNMP trap, detailing the occurrence of the event, as depicted in box D2.

The event message is then conveyed to and written in the SEL 24, as shown in box V1. Simultaneously, the event message is conveyed to the CEL 26, as shown in box V2. If the CEL 26 has been configured to track that event, i.e. it is a selected event, the event message is then written into the CEL 26, as shown in box V3. Once the event message is written into an event log, it is maintained there in accordance with that log=s configuration. The contents of the SEL 24 and CEL 26 may be examined as described above.

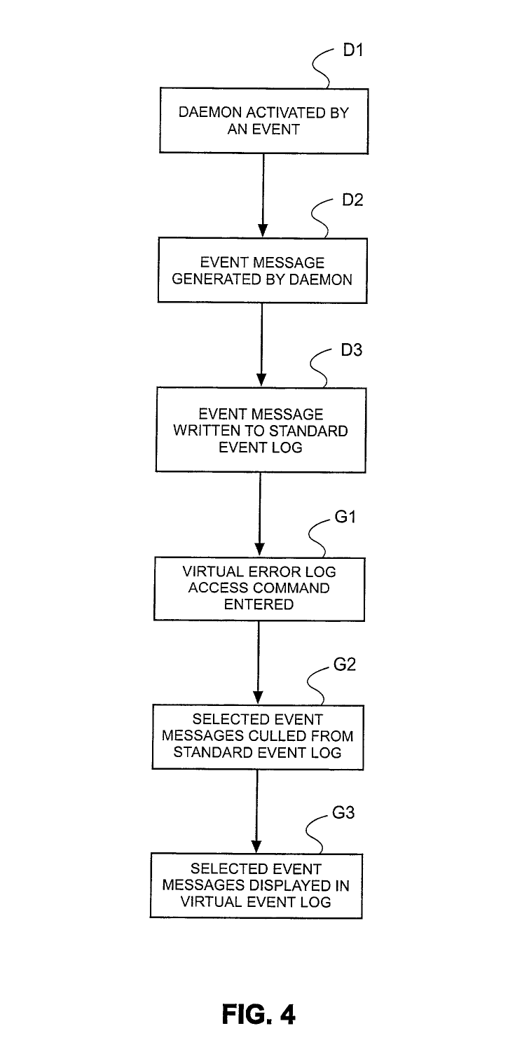

Turning to FIG. 4, another possible embodiment of a process for tracking printer events is described. For illustrative purposes, this process will be discussed as it would take place in connection with the embodiment of FIGS. 1 and 2, but it will be appreciated that the process may be used on any suitable system. As with the process depicted in FIG. 3, a daemon 29, such as an SNMP device, monitors the printer 10 for the occurrence of an event, such as the usage of a printer mechanical component like a collator or stapler. It will, of course, be appreciated that any event occurring on the printer may be monitored and that any suitable monitoring device or program may be used and is within the scope of the present invention. The daemon 29 is activated by the occurrence of the triggering event, as shown in box D1. Upon the occurrence of the event, daemon 29 generates an event message, such as an SNMP trap, detailing the occurrence of the event, as depicted in box D2. The event message is then conveyed to and written in the SEL 24, as shown in box D3.

When a user desires to examine the VCEL 27, a command to access the VCEL 27 is input by the user as shown in box G1. This may be accomplished by entering a command in the printer control panel display, in a utility such as WebJetAdmin, or by any other suitable method known to those skilled in the art. The SEL 24 is then examined and selected event messages are culled therefrom as shown in box G2. The selection of selected error messages may be entered as part of the access command, it may be maintained in memory 18, or a default selection may be used. Optionally, the culled selected error messages may be stored in a new location in memory 18, in a memory of a workstation 42, or otherwise, but this is not required.

The selected error messages are then displayed, preferably as a listing, as VCEL 27, as shown in box G3. The display is preferably at a workstation 42, although it may be on any suitable display screen. The display is preferably a web page, or web page-like interface displayed in a web browser program and preferably contains commands allowing the attributes of VCEL 27 to be altered.

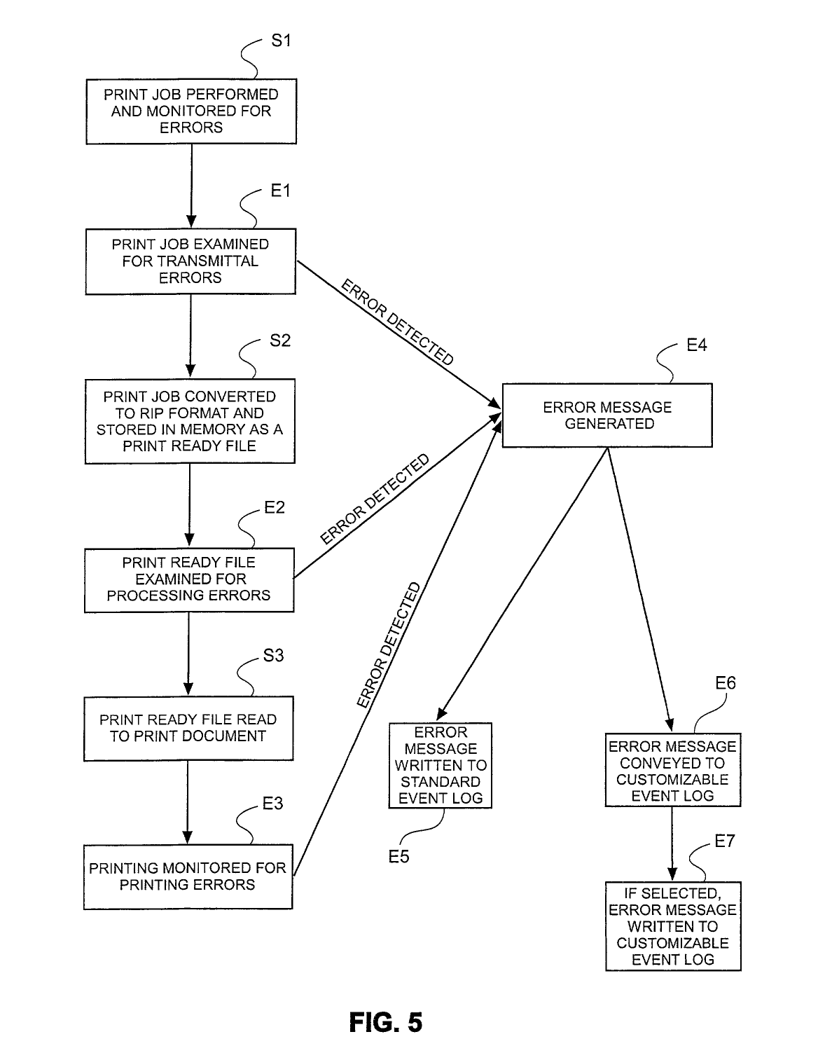

In FIG. 5, one possible embodiment of a process for detecting and tracking printer errors is described. As with FIG. 3, for illustrative purposes, this process will be discussed as it would take place in connection with the embodiment of FIGS. 1 and 2, but it will be appreciated that the process may be used on any suitable system. As shown in box S1, printer 10 receives a print job. This print job may either be sent as a data transmission by a workstation 42 or downloaded directly from a print buffer by the printer 10. In the embodiments of FIGS. 1 and 2 this print job is received through the network interface 14. Preferably, the print job is a data transmission in PDL format. An error detector 28, as described above, then examines the print job for errors, as shown in box E1. If no errors are detected, the print job is converted into a RIP format, preferably by a series of instructions executed by the microprocessor 12, and stored in the job retention memory 25 as a print ready file, as shown in box S2. The error detector 28 examines the print ready file for errors, either during conversion or prior to storage, represented in box E2.

If no errors are detected in the print ready file, the printer 10 uses the print ready file to control the mechanical printing components 30 through the printing steps to generate a printed document, as depicted in box S3. Preferably, a series of instructions executed by microprocessor 12 are used to read the print ready file and control the mechanical components 30 accordingly. The error detector 28 monitors the mechanical components 30 through the printing steps to determine if an error occurs, as shown in box E3.

If error detector 28 detects an error at any of the error detecting steps, an error message is generated as shown in box E4. The error message may be generated by the error detector 28 or by another printer 10 component. In some preferred embodiments, the error message is then written into the SEL 24 that is kept in the memory 18 of the printer 10 as shown in box E5.

The error message is then conveyed to the CEL 26, as depicted in box E6. If the error message is of a type selected to be tracked in the CEL 26, the error message is selected and written into the CEL 26, as shown in box E7. If the error message is not a selected event for tracking in the CEL 26, it is accepted.

Alternatively, it will be appreciated that the error message may be maintained in SEL 24 and a VCEL 27 generated as described with respect to FIG. 4 or by a comparable process. Such alternatives are within the scope of the present invention.

It will be appreciated from the above exemplary process that a printer error can be considered as a printer event to be tracked, similar to any other printer event. Similar processes for printer events can be designed and implemented according to the principles of the present invention, and all such processes are within the scope of he present invention.

Accordingly, the present invention includes a method of selectively tracking events occurring on a printer. This method may be practiced by providing a printer which includes a memory. The printer may include all the other features necessary to perform printing functions and any optional equipment. At least a first event log will be provided and maintained in the memory, although an event log may be maintained as a static event log unavailable to a user. The first event log is configurable by a user of the printer and the method includes the act of configuring the event log to accept and maintain a selection of selected event messages. A monitoring device will be provided to detect an event occurring on the printer. The monitoring device is activated in response to the event, generating an event message with the monitoring device upon activation. The event message is conveyed to the first event log. The event message is examined before, or after, being conveyed to the event log to determine if it is a selected event message. If it is a selected event message, it is written into the first event log to be maintained for tracking. It is preferred that the first event log be maintained as a wraparound file.

This method may further include providing a second event log maintained in the printer memory, conveying the event message to that second event log, and writing the event message into the second event log for maintaining the tracking of the event. It is preferred that the second event log be configurable by a printer user, such as a network administrator. Where this is available, the method is preferred to include the act of configuring the second event log to accept and maintain selected event messages. Event messages are examined to determine if they are selected event messages and are maintained in the second event log if they are. Alternatively, the method may include displaying selected event messages in a virtual event log. This may be accomplished by culling selected event messages from at least the first event log and displaying those selected messages in a virtual event log. One type of printer event that may be monitored is an error in printer function. Where errors are monitored, the monitoring device may be an error detector.

The present invention further includes a method of simultaneously tracking events on a printer. This method may be practiced by providing a printer, which includes a memory and providing first and second event logs maintained in that memory. The method further includes providing a monitoring device to detect an event occurring on the printer and activating the monitoring device in response to the occurrence of that event, thereby generating an event message with the monitoring device. The event message is then written into the first and second event logs, which are separately maintained to allow events to be tracked in each.

It is preferred that the second event log be configurable by a printer user, such as a network administrator. Where this is done, it is preferred the method further include the acts of configuring the second event log to accept and maintain selected event messages, and examining each generated event message to determine if it is a selected event message. It is further preferred that the second event log is configurable by the user through a web page-like interface. The interface may be generated and accessed through a printer network utility program, like WebJetAdmin, generated and accessed via the printer control panel or by any other suitable method. It is preferred that the interface allows the user to reset the second event log. By contrast, it is preferred that the first event log may be reset only by replacing a printer component or by the entry of a command by field support personnel or the printer manufacturer. The event detected may be an error in printer function. Where this is done, the monitoring device may be an error detector. Other suitable monitoring devices include daemons, SNMP devices, and other monitoring programs and processors configured for monitoring printer functions.

The present invention thus advantageously provides methods and systems of tracking events occurring on printers, such that an end user may configure and adapt the tracking to optimize its benefits, while at the same time, more standard tracking is done to allow a manufacturer to debug and repair printers. Use of the present invention is particularly advantageous for monitoring specific printer events or errors for analysis in considering upgrades or replacements.

It will be appreciated by those skilled in the art that illustrated embodiments herein described are not intended to limit the invention or the scope of the appended claims. Various combinations and modifications of the preferred embodiments could be made without departing from the scope of the present invention and all such modifications are within the scope of the present invention. For example, it is understood that while the methods and apparatus of the present invention have been described in relation to a workstation interacting with a printer, one of skill in the art will recognize that the present invention may be utilized with a wide variety of networked and/or Web based devices and may be implemented through firmware with existing printer hardware.

Thus, while certain representative embodiments and details have been shown for purposes of illustrating the invention, it will be apparent to those skilled in the art that various changes in the invention disclosed herein may be made without departing from the scope of the invention, which is defined in the appended claims.

What is claimed is:

1. A method of selectively tracking events occurring on a printer, the method comprising:
providing a printer including a memory;
providing a first event log maintained in said memory, said first event log configurable by a user of said printer;
configuring said first event log to accept and maintain a selection of selected event messages;
providing a monitoring device to detect an event occurring on said printer;
activating said monitoring device in response to said event;
generating an event message with said monitoring device upon said activation;
conveying said event message to said first event log;
examining said event message to determine if said event message is one of said selected event messages; and
writing said event message into said first event log if said event message is said one of said selected event messages, such that said one of said selected event messages is maintained therein for tracking said event.

2. The method of claim 1, further comprising:
providing a second event log maintained in said memory;
conveying said event message to said second event log; and
writing said event message into said second event log, such that said event message is maintained therein for tracking said event.

3. The method of claim 2, wherein said second event log includes one of an event log configurable by said user of said printer and an event log not configurable by a user of said printer.

4. The method of claim 3, further comprising configuring said second event log to accept and maintain said selection of selected event messages.

5. The method of claim 4, further comprising examining said event message to determine if said event message comprises said one of said selected event messages.

6. The method of claim 1, wherein said event comprises an error occurring on said printer.

7. The method of claim 1, wherein said first event log comprises a wraparound file.

8. The method of claim 1, further comprising: selecting said selected event messages from said first event log; and displaying said selected event messages in a virtual event log.

9. The method of claim 8, wherein said virtual event log comprises an event log displayed as a web page-like interface.

10. A method of simultaneously tracking events on a printer, comprising:
providing a printer including a memory;
providing a first event log maintained in said memory;
providing a second event log maintained in said memory;
providing a monitoring device to detect an event occurring on said printer;
activating said monitoring device in response to said event;
generating an event message with said monitoring device upon said activation;
writing said event message into said first event log, such that said event message is maintained therein for tracking said event; and
writing said event message into said second event log, such that said event message is maintained therein for tracking said event.

11. The method of claim 10, wherein said second event log includes an event log configurable by a user of said printer.

12. The method of claim 11, further comprising configuring said second event log to accept and maintain a selection of selected event messages.

13. The method of claim 12, further comprising examining said event message to determine if said event message includes one of said selected event messages.

14. The method of claim 12, wherein said user can configure said second event log through a web page-like interface.

15. The method of claim 14, wherein said web page-like interface comprises a web page-like interface generated within a printer network utility program.

16. The method of claim 14, further comprising accessing said web page-like interface through a printer control panel.

17. The method of claim 12, wherein said second event log may be reset by said user using an interface.

18. The method of claim 10, wherein said first event log may be reset by replacing a printer component.

19. The method of claim 10, wherein said event includes an error occurring on said printer.

20. A system for simultaneously tracking printer errors, comprising:
a printer including a memory;
a first event log maintained in said memory;
a second event log maintained in said memory; and
a monitoring device to detect an event occurring on said printer, said monitoring device configured to activate and generate an event message upon detection of said event, and to convey said event message to said first event log and said second event log.

21. The system of claim 20, wherein said second event log includes a second event log configurable by a user of said printer to accept and maintain a selection of selected event messages.

22. The system of claim 21, wherein said second event log examines said event messages to determine if said event messages are one of said selected event messages, and stores and maintains said selected event messages.

23. The system of claim 21, wherein said second event log includes a second event log configurable by said user of said printer using a web page-like interface to designate said selected event messages.

24. A method of selectively tracking events occurring on a printer having a monitoring device for detecting at least one event, the method comprising:
creating a first event log for said printer for maintaining a selection of selected event messages;
activating said monitoring device in response to said event;
generating an event message with said monitoring device upon said activation;
conveying said event message to said first event log;
examining said event message to determine if said event message is one of said selected event messages; and
writing said event message into said first event log if said event message is said one of said selected event messages, such that said one of said selected event messages is maintained therein for tracking said event.

25. The method of claim 24, further comprising:
creating a second event log for said printer;
conveying said event message to said second event log; and
writing said event message into said second event log for tracking.

26. The method of claim 25, further comprising configuring said second event log to accept and maintain said selection of selected event messages.

27. The method of claim 26, further comprising examining said event message to determine if said event message comprises said one of said selected event messages.

28. The method of claim 24, wherein said first event log comprises a wraparound file.

29. The method of claim 24, further comprising:
selecting said selected event messages from said first event log; and
displaying said selected event messages in a virtual event log.

30. The method of claim 29, wherein said virtual event log comprises an event log displayed as a web page-like interface.

31. A method of simultaneously tracking events on a printer having a monitoring device, comprising:
creating a first event log for said printer;
creating a second event log for said printer;
detecting an event occurring on said printer;
activating said monitoring device in response to said event;
generating an event message with said monitoring device upon said activation;
writing said event message into said first event log, such that said event message is maintained therein for tracking said event; and
writing said event message into said second event log, such that said event message is maintained therein for tracking said event.

32. The method of claim 31, further comprising configuring said second event log to accept and maintain a selection of selected event messages.

33. The method of claim 32, further comprising examining said event message to determine if said event message includes one of said selected event messages.

34. The method of claim 32, wherein said user can configure said second event log through a web page-like interface.

35. The method of claim 34, wherein said web page-like interface comprises a web page-like interface generated within a printer network utility program.

36. The method of claim 34, further comprising Accessing said web page-like interface through a printer control panel.
